(19) United States
(12) Patent Application Publication
(10) Pub. No.: US 2025/0045980 A1
(43) Pub. Date: Feb. 6, 2025

(54) SURFACE TEXTURE GENERATION FOR THREE-DIMENSIONAL OBJECT MODELS USING GENERATIVE MACHINE LEARNING MODELS

(71) Applicant: NVIDIA Corporation, Santa Clara, CA (US)

(72) Inventors: Tianshi CAO, Toronto (CA); Kangxue YIN, Toronto (CA); Nicholas Mark Worth SHARP, Seattle, WA (US); Karsten Julian KREIS, Vancouver (CA); Sanja FIDLER, Toronto (CA)

(73) Assignee: NVIDIA Corporation, Santa Clara, CA (US)

(21) Appl. No.: 18/361,987

(22) Filed: Jul. 31, 2023

(51) Int. Cl. G06T 11/00; G06T 5/00; G06T 15/20

(52) U.S. Cl. CPC G06T 11/001; G06T 5/70; G06T 15/20; G06T 2207/20182

(57) ABSTRACT

Aspects of this technical solution can obtain, according to a plurality of cameras oriented toward the surface of a three-dimensional (3D) model having a surface including a two-dimensional (2D) texture model, input according to corresponding views from the plurality of cameras of the 2D texture model on the surface of the 3D model, and generate, according to the input and according to a model configured to generate a two-dimensional (2D) image, an output including a 2D texture for the 3D model, the output responsive to receiving an indication of the 3D model and the 2D texture.

### TECHNICAL FIELD

The present implementations relate generally to computer modeling, including but not limited to texture generation for three-dimensional models according to text-based prompts.

### INTRODUCTION

Computational systems are increasingly expected to provide a wide array of visual data in an increasingly diverse number of variants according to user preferences or settings of the visuals. Users increasingly demand the ability to customize or tailor the appearance of visuals to their preferences or expectations. However, conventional systems lack the ability to generate visuals with uniformly convincing visual properties.

### SUMMARY

Embodiments of the present disclosure relate to machine learning models that generate two-dimensional (2D) textures corresponding to particular three-dimensional (3D) geometries and according to a text prompt describing one or more of an object and a texture. For example, a machine learning model can obtain a text prompt corresponding to input to a generative artificial intelligence (AI) system. The text prompt can include, for example and without limitation, a description of a 3D object and a description of a 2D texture desired for that 3D object. The machine learning model can obtain or otherwise receive a 3D object model corresponding to the content of the text prompt, and a 2D texture model corresponding to the text prompt or corresponding to a noise distribution in a 2D space. For example, a texture model can correspond to a latent texture defined according to a diffusion model, and a texture can correspond to a visible texture defined according to a visible color palette. The machine learning model can apply the 2D texture model to the exterior surface (e.g., surface mesh) of the 3D object model to “wrap” the object in the texture model. The machine learning model can iterate over time and over a number of views and viewpoints of the 3D object including the 2D texture model, to generate a 2D texture corresponding to the text prompt. This technical solution can thus achieve a technical improvement of generating a 2D texture for a 3D object in a reduced time period and/or using fewer computing resources. The technical solution can thus generate 2D textures corresponding to 3D objects at an accuracy and at a speed beyond the capability of manual texture creation to achieve. Thus, a technical solution for texture generation for three-dimensional models according to text-based prompt input is provided.

At least one aspect is directed to a processor that can include one or more circuits. The processor can obtain input according to corresponding views from a plurality of viewpoints (perspectives) of a 2D texture model on the surface of a 3D model. The processor can generate, according to the input and according to a model configured to generate a two-dimensional (2D) image, an output that can include a 2D texture for the 3D model. In one or more embodiments, the output may be produced responsive to receiving an indication of the 3D model and the 2D texture.

At least one aspect is directed to a system. The system can include a memory and one or more processors configured. The system can obtain views of a three-dimensional (3D) model from a set of vantage points that at least partially envelopes a surface of the 3D model, each view corresponding to a portion of a two-dimensional (2D) texture model on the surface of the 3D model. The system can generate, according to the views and according to a model configured to generate a 2D image, an output that can include a 2D texture for the 3D model. In one or more embodiments, the output may be produced in response to receiving an indication of the 3D model and the 2D texture.

At least one aspect is directed to a method. The method can include obtaining input according to a plurality of portions of a two-dimensional (2D) texture model on a surface of a three-dimensional (3D) model. The method can include generating, according to the input and according to a model configured to generate a 2D image, an output that can include a 2D texture for the 3D model. In one or more embodiments, the output may be generated responsive to receiving an indication of the 3D model and the 2D texture.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The foregoing aspects and features and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with present implementations.

FIG. 2 depicts an example surface projection of an object, in accordance with present implementations.

FIG. 3 depicts an example diffusion iteration, in accordance with present implementations.

FIG. 4 depicts an example multiple viewpoint capture architecture, in accordance with present implementations.

FIG. 5 depicts an example texture surface, in accordance with present implementations.

FIG. 6 depicts an example texture processing architecture, in accordance with present implementations.

FIG. 7 depicts an example texture, in accordance with present implementations.

FIG. 8A depicts an example viewpoint capture of a 3D model with contrasting texture, in accordance with present implementations.

FIG. 8B depicts an example viewpoint capture of a 3D model with complementary texture, in accordance with present implementations.

FIG. 9 depicts an example textured 3D object, in accordance with present implementations.

FIG. 10 depicts an example model architecture, in accordance with present implementations.

FIG. 11 depicts an example network system, in accordance with present implementations.

FIG. 12 depicts an example computer system, in accordance with present implementations.

FIG. 13 depicts an example computer architecture, in accordance with present implementations.

FIG. 14 depicts an example method of texture generation for three-dimensional models according to text-based prompt input, in accordance with present implementations.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

This technical solution can iteratively process a 2D texture applied to a 3D object, according to a plurality of iterative operations. For example, a machine learning model can iterate over multiple versions of a 2D texture model to denoise the texture model with respect to the 3D object model. Iteration of the 2D texture model with respect to denoising can correspond to an outer loop of the texture generation process of the machine learning model of this technical solution. For example, the machine learning model can, within each iteration of the outer loop, iterate over a plurality of camera views (viewpoints), one or more (e.g., each) of which may be oriented toward a particular portion of the 3D object and encompassing a portion of the 2D texture model applied to that particular portion of the 3D object model. For example, each viewpoint can correspond to a virtual camera having a viewpoint from which the 3D object model is rendered with the 2D texture model. The technical solution can include a plurality of viewpoints each having particular perspective or viewing angle to, in the aggregate, render the entirety of the 3D object model with the 2D texture model, or a substantial portion of the 3D object model with the 2D texture model. One or more (e.g., each) of the viewpoints can be placed at the same or a corresponding distance from a surface of the 3D object in front of the viewpoint. For example, a viewpoint can correspond to a virtual camera. The virtual camera can correspond to a perspective in a virtual environment from a particular point or location in the virtual environment oriented to view a particular portion of the virtual environment.

This technical solution can apply a machine learning model iteratively to the 2D texture model according to each of the portions of the 2D texture model visible on the 3D object model. For example, a diffusion model can iterate in sequence of some, each, or all of a plurality of viewpoints oriented toward the 3D object model having the 2D texture model, to denoise the entire surface of the 2D texture model without occlusion or fragmentation of the 2D texture model at portions of the 3D object where the 2D texture becomes hidden from a particular viewpoint. For example, iteration over a plurality of viewpoints can provide at least a technical improvement to increase accuracy of the 2D texture model by eliminating artifacts and errors at the edge of an object blocked from view by the front to the object. The technical solution can provide a technical improvement to increase efficiency and reduce computational resources required, by weighting portions of a field of view of a viewpoint according to distance to the surface of the 3D object. For example, the technical solution can identify an optimal distance from the viewpoint to a surface of the 3D object having the 2D texture model, where the optimal distance provides input resulting in higher accuracy of a 2D texture to a text prompt, or faster denoising of a 2D texture according to a machine learning model. Portions of a 2D texture model located at portions of a 3D object model outside of the optimal distance can be weighted to reduce their impact on the machine learning model iteration over the 2D texture model. Where multiple viewpoints cover the same point(s) on the 3D object model (and corresponding points of the 2D texture model), the technical solution can select a portion of the 2D texture model having a weight or metric corresponding to or closest to an optimal distance. For example, an optimal distance can be a particular distance or a range of distances (e.g., within a threshold). Whether the distance of the viewpoint to the pixel is within the threshold for being an optimal distance may be determined according to a degree of distortion of or within an output of the diffusion model. Thus, this technical solution can efficiently iterate among multiple views of a 2D texture model applied to a 3D object, beyond capability of manual pixel analysis.

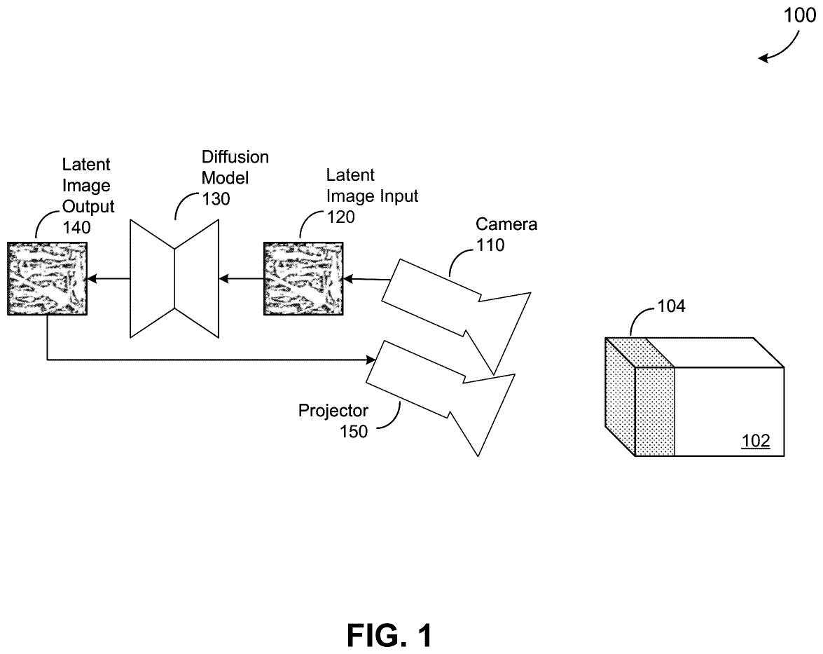

FIG. 1 depicts an example system, in accordance with present implementations. As illustrated by way of example in FIG. 1, a system 100 can include at least an object 102, a camera (viewpoint) 110, a latent image input 120, a diffusion model 130, a latent image output 140, and a projector 150.

The object 102 can correspond to a 3D model associated with or present in a virtual environment. For example, the object 102 can include one or more surfaces arranged to enclose or partially enclose a volume. For example, the object 102 can correspond to a particular shape, or a class or category of shapes. A shape can include, but is not limited to, a figure of a human, a vehicle, a face or bust of a human, a building or edifice, a plant, an animal, or any combination thereof. For example, the shape can correspond to an individual person or to a man, a woman, a boy, a girl, or an alternatively gendered adult or minor. For example, the shape can correspond to a particular make and model of a vehicle, or to a class of a vehicle, including but not limited to a sedan, a sport utility vehicle (SUV), a semi truck, a pickup truck, or a coupe. The object 102 can include a viewable portion 104.

The viewable portion 104 can correspond to a portion of the object 102 within a field of view of the camera 110. For example, the viewable portion 104 can correspond to one or more surfaces or portions of surfaces located within a viewing angle in one or more axes from a direction of orientation of the camera 110. For example, the viewable portion 104 can correspond to one or more surfaces or portions of surfaces located at a distance from the camera 110 that satisfies one or more of a minimum viewing distance or a maximum viewing distance in one or more axes from a direction of orientation of the camera 110. For example, a field of view corresponding to the camera can be bounded by a cone extending and expanding along a line from a center of a viewpoint of the camera 110, and bounded by a minimum distance from the viewpoint of the camera 110 and a maximum distance from the viewpoint of the camera 110.

The camera 110 can correspond to a virtual detector of a portion of a virtual environment. The camera 110 can detect the object 102 or the viewable portion 104 thereof according to the field of view corresponding to the camera 110. For example, the camera 110 (e.g., a virtual detector that processes data corresponding to the camera 110) can detect the viewable portion 104 as a 2D plane corresponding to a portion of a surface of the object 102. For example, the camera 110 can detect a latent image applied to the surface of the object 102. The camera 110 can correspond to one or more of a plurality of cameras. Stated otherwise, the system 100 can comprise one or more cameras, each detecting the object 102 and/or a different viewable portion thereof according to a field of view, wherein the one or more cameras collectively detect an entirety of the one or more surfaces of the object 102.

The latent image input 120 can correspond to a 2D image detected by the camera viewpoint 110. The latent image input 120 can correspond to a 2D image of the viewable portion 104. For example, a latent image can correspond to a 2D surface having one or more properties at one or more points thereon. For example, a latent image property can correspond to a characteristic of the point in portion of a spectrum corresponding to visible light, or independent of the portion of the spectrum corresponding to visible light.

The diffusion model 130 can generate or modify the latent image input 120 to conform to a parameter corresponding to a texture. For example, the diffusion model 130 can include a machine learning model configured to generate a 2D surface corresponding to a surface of the object 102. For example, the diffusion model 130 can generate the latent image output 140 according to one or more parameters including a text prompt identifying a texture to be generated by the diffusion model 130. For example, the diffusion model 130 can generate the latent image output 140 according to a parameter including a text prompt identifying the object 102 on which the texture is to be generated by the diffusion model 130.

The latent image output 140 can correspond to a 2D image generated by the diffusion model 130 or modified by the diffusion model 130 according to the latent image input 120. The latent image output 140 can include a 2D surface modified by the diffusion model 130 to correspond to the texture indicated by the text prompt according to the latent image input 120. For example, the latent image output 140 can correspond to an iteration of the diffusion model 130 with respect to latent image formation. The iteration of the diffusion model 130 with respect to latent image formation can correspond to an “outer loop” of a texture generation process. An outer loop can include an iterative loop that includes one or more steps. For example, the outer loop can include an iterative loop that iterates over views of one or more camera of the system 100 each having a view oriented toward a different portion of the object 102.

The projector 150 can correspond to a virtual applicator of a portion of a virtual environment. The projector 150 can obtain the latent image output 140, and apply the 2D texture to the object 102 in a configuration or orientation corresponding to the latent image input 120 and the viewable portion 104. For example, the projector 150 can apply the latent image output 140 to the viewable portion 104 as a 2D plane.

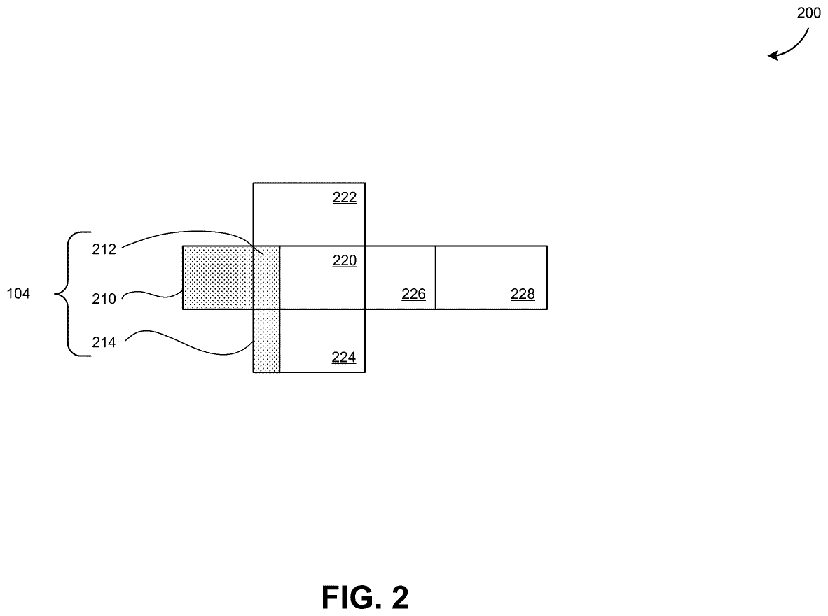

FIG. 2 depicts an example surface projection of an object, in accordance with present implementations. As illustrated by way of example in FIG. 2, a surface projection 200 of an object can include at least a viewable left surface 210, a viewable portion of an upper surface 212, a viewable portion of a front surface 214, an unviewed portion of an upper surface 220, an unviewed rear surface 222, an unviewed front surface 224, an unviewed right surface 226, and an unviewed bottom surface 228. The surface projection 200 can correspond to a flattened 2D surface corresponding to the exterior surface of the object 102, including the viewable portion 104. For example, one or more cameras including the camera 110 can be oriented toward the object 102 from various perspectives/positions to collectively capture the surface projection 200 from those viewpoints.

The viewable left surface 210 can correspond to a portion of a left side surface of the object 102 that is within the field of view of the camera 110. The viewable portion of upper surface 212 can correspond to a portion of an upper side surface of the object 102 that is within the field of view of the camera 110. The viewable portion of front surface 214 can correspond to a portion of a front side surface of the object 102 that is within the field of view of the camera 110. The viewable left surface 210, the viewable portion of upper surface 212, and the viewable portion of front surface 214 can correspond collectively to the viewable portion 104.

The unviewed portion of upper surface 220 can correspond to a portion of the upper side surface of the object 102 that is outside the field of view of the camera 110. The unviewed rear surface 222 can correspond to a rear side surface of the object 102 that is outside the field of view of the camera 110. The unviewed front surface 224 can correspond to a portion of the front side surface of the object 102 that is outside the field of view of the camera 110. The unviewed right surface 226 can correspond to a right-side surface of the object 102 that is outside the field of view of the camera 110. The unviewed bottom surface 228 can correspond to a bottom side surface of the object 102 that is outside the field of view of the camera 110. One or more of the unviewed surfaces 222, 223 and 228 or unviewed portions 220 and 224 can be viewable by a camera having a viewpoint oriented toward those portions of the surface projection 200 corresponding to the object 102.

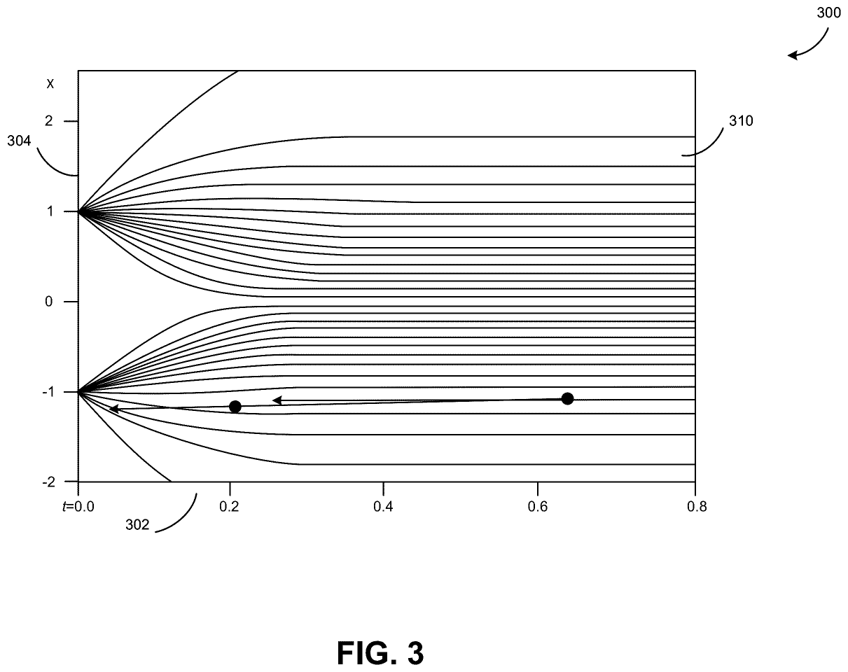

FIG. 3 depicts an example diffusion iteration, in accordance with present implementations. As illustrated by way of example in FIG. 3, an example diffusion iteration 300 can include at least a time axis 302, an output characteristic 304, and model characteristics 310. The diffusion iteration 300 can correspond to output of the diffusion model 130 over a plurality of iterations including the outer loop. For example, the diffusion iteration can correspond to multiple iterations through the diffusion model over time, and can include input from one or more cameras concurrently at each time or at sequential times.

The time axis 302 can identify a state of the output of the diffusion model 130 at a particular time. For example, the time axis 302 can identify a plurality of states, each corresponding to various data points having coordinates matching or corresponding to particular values along the time axis 302. For example, the time axis 302 can indicate an order of generation or modification of latent images by the diffusion model 130. The output characteristic 304 can indicate a state of the output of the diffusion model 130 at a particular time. For example, the time axis 302 can indicate a plurality of states, each corresponding to one or more output data points having a coordinate matching or corresponding to a particular value along the time axis 302. For example, the time axis 302 can indicate properties of one or more latent images generated or modified by the diffusion model 130. The model characteristics 310 can correspond to one or more point in a diffusion model space corresponding to input or output of the diffusion model 130 at one or more particular times. For example, model characteristics 310 can store or indicate values of a latent image, and can correspond to a 2D point space indicating change in a latent image toward a texture indicated by a text prompt.

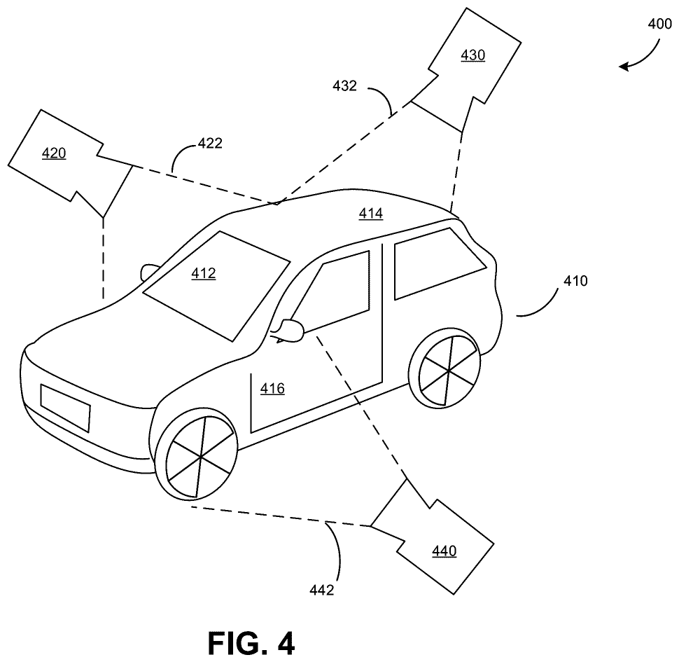

FIG. 4 depicts an example multiple viewpoint capture architecture, in accordance with present implementations. As illustrated by way of example in FIG. 4, an example multiple viewpoint capture architecture 400 can include at least an object 410, a first viewable portion 412, a second viewable portion 414, a third viewable portion 416, a first camera (viewpoint) 420, a second camera (viewpoint) 430, and a third camera (viewpoint) 440.

The object 410 can correspond at least partially in one or more of structure and operation to the object 102. The object 410 can have a shape at least partially corresponding to a text prompt that describes an object. For example, the object 410 can correspond to a 3D model of an SUV, according to a text prompt that indicates “a red SUV.” The object 410 can have multiple surfaces or portions of a surface that can be viewed by one or more of the cameras 420, 430 and 440. The first viewable portion 412 can correspond to a first portion of a surface of the object 410 viewable by the first camera 420. For example, the first viewable portion 412 can correspond to a front portion of the object 410, and can include a portion of the surface of the object 410 corresponding to a windshield, a hood and a front portion of a roof of an SUV model corresponding to the object 410. The second viewable portion 414 can correspond to a second portion of the surface of the object 410 viewable by the second camera 430, and at least partially distinct from the first viewable portion 412. For example, the second viewable portion 414 can correspond to a top portion of the object 410, and can include a portion of the surface of the object 410 corresponding to a roof of an SUV model corresponding to the object 410. The third viewable portion 416 can correspond to a third portion of the surface of the object 410 viewable by the third camera 440, and at least partially distinct from the first viewable portion 412 and the second viewable portion 414. For example, the third viewable portion 416 can correspond to a side portion of the object 410, and can include a portion of the surface of the object 410 corresponding to a left fender, a left wheel, a portion of a hood, and a portion of a driver-side door of an SUV model corresponding to the object 410.

The first camera 420 can correspond at least partially in one or more of structure or operation to the camera 110. For example, the first camera 420 can have a viewpoint oriented toward the object 410 to render at least part of the object 410 viewable. The first camera 410 can be placed at a distance from the first viewable portion 412 of the surface that corresponds to or satisfies one or more distance thresholds. For example, the distance thresholds can correspond to a diffusion model, by indicating one or more distances at, before, or beyond which a particular diffusion model may detect a pixel at varying degrees of accuracy. The first camera 420 can include a first field of view 422. The first field of view 422 can correspond at least partially in one or more of structure or operation to a field of view of the camera 110. For example, the first field of view 422 can have a 2D boundary corresponding to the first viewable portion 412.

The second camera 430 can correspond at least partially in one or more of structure or operation to the camera 110. For example, the second camera 430 can have a viewpoint oriented toward the object 410 to render at least part of the object 410 viewable. The second camera 430 can be placed at a distance from the second viewable portion 414 of the surface that corresponds to or satisfies one or more distances thresholds of a diffusion model. The second camera 430 can include a second field of view 432. The second field of view 432 can correspond at least partially in one or more of structure or operation to a field of view of the camera 110. For example, the second field of view 432 can have a 2D boundary corresponding to the second viewable portion 414.

The third camera 440 can correspond at least partially in one or more of structure or operation to the camera 110. For example, the third camera 440 can have a viewpoint oriented toward the object 410 to render at least part of the object 410 viewable. The third camera 440 can be placed at a distance from the third viewable portion 416 of the surface that corresponds to or satisfies one or more distances thresholds of a diffusion model. The third camera 440 can include a third field of view 442. The third field of view 442 can correspond at least partially in one or more of structure or operation to a field of view of the camera 110. For example, the third field of view 442 can have a 2D boundary corresponding to the third viewable portion 416. Thus, the first camera 420, the second camera 430, and the third camera 440 can collectively render a greater portion of the object 410 viewable than each camera alone. Any number of cameras (viewpoints) can be oriented around and toward the object 410 or any 3D object as discussed herein, to render viewable all or substantially all of a surface of the 3D object.

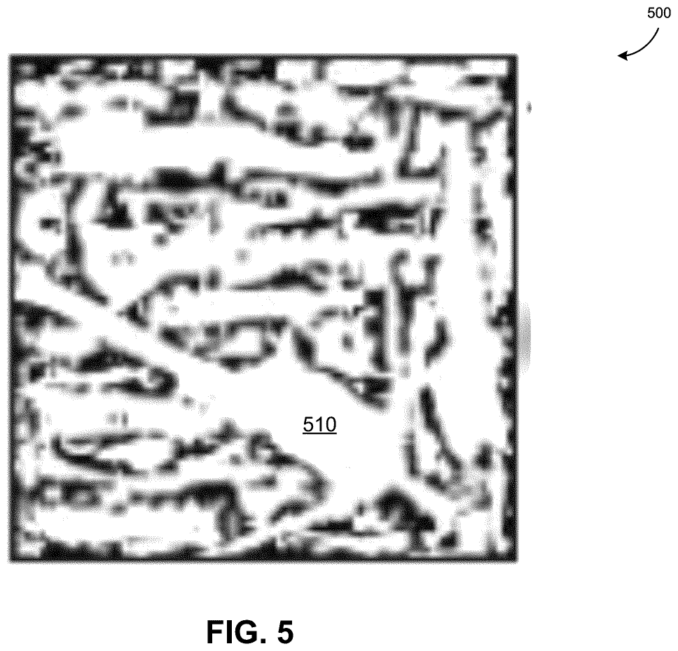

FIG. 5 depicts an example texture surface, in accordance with present implementations. As illustrated by way of example in FIG. 5, a texture surface 500 can include at least a latent texture 510. The latent texture 510 can correspond at least partially in one or more of structure or operation to the latent image input 120, the latent image output 140, or the surface projection 200. For example, the latent texture 510 can be applied to the object 102 or the object 410 by the projector 150. For example, the latent texture 510 can be detected on a surface of the object 102 by the camera 110. For example, the latent texture 510 can be detected on a surface of the object 410, collectively or individually by one or more of the cameras 420, 430 and 440.

The latent texture 510 can have one or more particular values corresponding to one or more particular points of a surface of an object. For example, each point of the latent texture 510 can correspond to a point on a surface of the object 410. For example, a portion of the latent image 510 can correspond to a color, brightness, hue, transparency, or any combination thereof, but is not limited thereto. The latent texture 510 can be encoded as a latent value that corresponds to a visual property in a format compatible with the diffusion model, and is not limited to being encoded or stored with values that indicate visual properties in a visual spectrum. For example, the latent texture 510 can store latent values that are distinct from colors defined in RGB or CMYK palettes, but can be converted between latent values and color values. Latent values can correspond to one or more pixels in a color space. For example, a single latent value can correspond to a single pixel in a latent image space, and can also correspond to a plurality of pixels in a color space. For example, this plurality of pixels in the color space that correspond to the single latent value can be considered a patch of pixels in the color space. For example, the patch of pixels can be associated with one another according to one or more properties or thresholds, including but not limited to distance or color. For example, a neural network can operate on one or more patches to provide a technical improvement of fast performance of execution of processing of image pixels. For example, the neural network can correspond to, but is not limited to, a convolutional neural network.

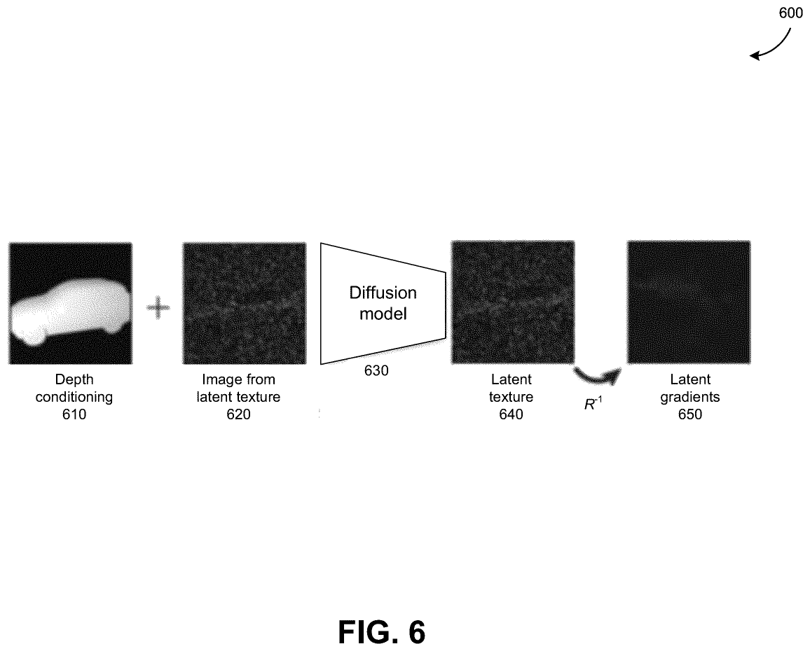

FIG. 6 depicts an example texture processing pipeline, in accordance with present implementations. As illustrated by way of example in FIG. 6, a texture processing pipeline 600 can include a depth conditioning stage, to condition the depth according to a 3D model of an object 610. The texture processing pipeline 600 can include an image generation stage, to generate the image based, at least in part, on a latent 2D texture 620 or an inferencing stage. For example, the inferencing is performed using (for example and without limitation) a diffusion model 630, a latent texture generation stage that generates the latent textures according to a diffusion model 640. The texture processing pipeline 600 can include a latent gradient output computation stage 650, to compute the latent gradient output using the latent texture.

In one or more embodiments, during the depth conditioning stage 610, a 3D model can be identified corresponding to an input that identifies or at least partially describes an object. For example, the depth conditioning 610 can include retrieving, obtaining, generating, or modifying a 3D model to correspond to or that corresponds to text input provided by a user through a user interface that describes an aspect of an object. Thus, depth conditioning can provide at least a technical improvement of significantly reducing computation resources to generate a texture for a particular object by obtaining an object to bypass a texture rendering process including constructing, rendering, or applying a 3D object in a 3D coordinate space to render the 2D texture.

In one or more embodiments, the image generation stage 620 can correspond at least partially in one or more of structure or operation to the operation of the camera 110 to capture the latent image input 120. The inferencing stage 630 can include providing the latent image input 120 to a generative model (e.g., the diffusion model 130). For example, the diffusion model depicted in the texture processing architecture 600 can correspond at least partially in one or more of structure or operation to the diffusion model 130. The latent texture generation stage 640 can include obtaining the latent image output 140 according to the output of the diffusion model 130.

The latent gradient output computation stage 650 output can include a transformation of one or more portions of a latent texture. For example, computing the latent gradient 650 can correspond to generating a 2D latent image that indicates a level of diffusion or divergence between pixels of a surface projection. For example, the latent gradient 650 can indicate a degree of difference between adjacent pixels or previous pixels at that location as generated in earlier iterations of a latent image by a diffusion model. Thus, the latent gradient 650 can provide a technical improvement to indicate a level of cohesion between portions of a latent image captured by different viewpoints.

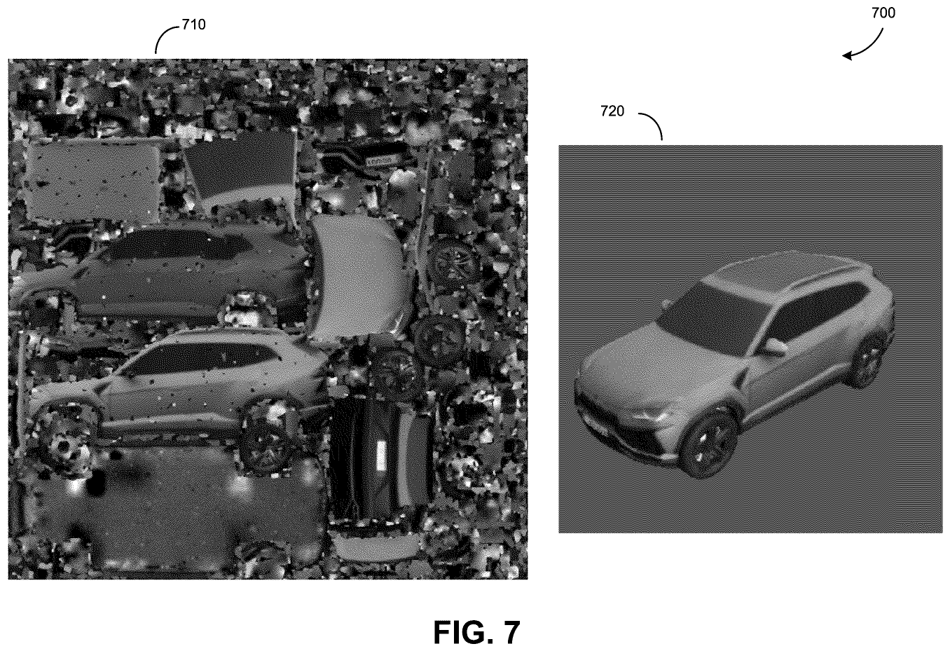

FIG. 7 depicts an example texture, in accordance with present implementations. As illustrated by way of example in FIG. 7, a texture 700 can include at least a 2D texture 710, and a 2D texture applied to 3D object 720.

The 2D texture 710 can correspond at least partially in one or more of structure and operation to the surface projection 200. The 2D texture 710 can correspond to a latent image that has been converted to a rendering in a color space visible to the human eye, but is not limited thereto. For example, the 2D texture 710 can be rendered from a latent image or a latent gradient into an RGB color space. For example, the 2D texture 710 can correspond to a surface of an object corresponding to an SUV. For example, the 2D texture 710 can be provided as output in response to a text prompt including “a red SUV” provided to a system as discussed herein. The 2D texture 710 can correspond to a flattened image to be wrapped around a 3D model obtained in response to the text prompt to be compatible with the text prompt.

The 2D texture applied to 3D object 720 can correspond to the 2D texture 710 wrapped to correspond to a surface of a 3D object corresponding to the text prompt. For example, wrapping of the 2D texture 710 can correspond to application of the surface projection 200 onto the object 102, where the object 102 corresponds to the 3D object on which the 2D texture 710 is applied. For example, the 2D texture 710 can include a number of pixels, some (e.g., each) corresponding to a particular location on a surface of a 3D object.

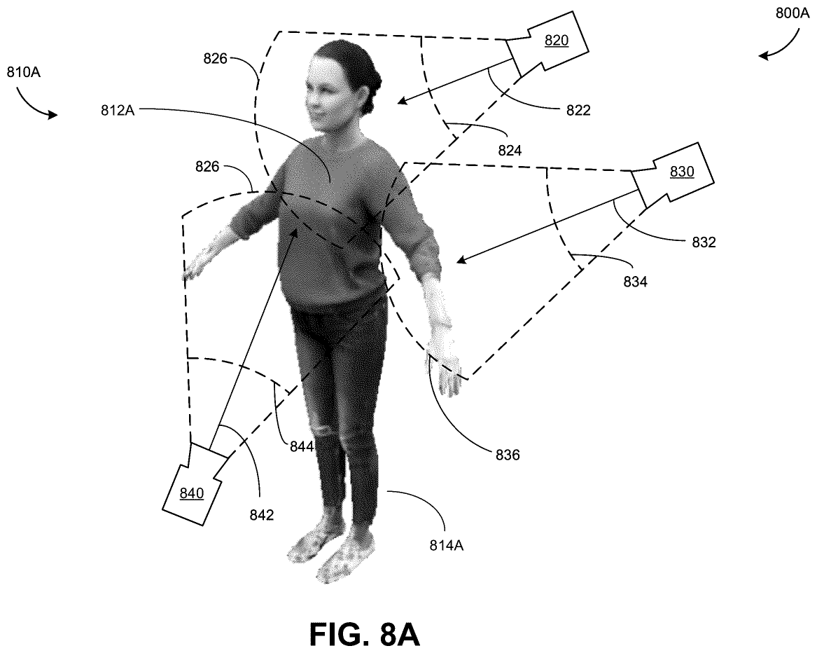

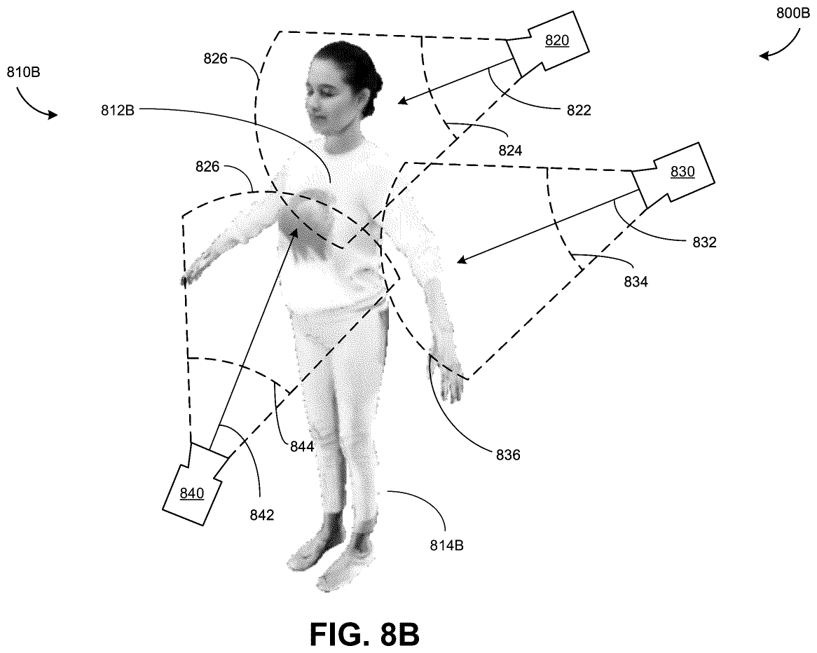

FIG. 8A depicts an example viewpoint capture of 3D model with contrasting texture, in accordance with present implementations. As illustrated by way of example in FIG. 8A, a viewpoint capture of 3D model with contrasting texture 800A can include at least an object 810A, an upper garment portion 812A, a lower garment portion 814A, a first camera 820, a second camera 830, and a third camera 840.

The object 810A can correspond at least partially in one or more of structure and operation to the object 102, and can include a surface that can correspond at least partially in one or more of structure or operation to the surface projection 200. For example, the object 810A can correspond to a 3D model of a woman wearing a sweater, jeans, and sneakers. The object 810A can include a surface having a particular color space as illustrated herein, but is not limited thereto. For example, the object 810A can have a surface having a latent texture or a latent gradient as discussed herein. For example, the object 810A can have a surface corresponding to a red sweater having a sweater texture and blue jeans having a denim texture. The surface of the object 810A can be generated by the system 100, and by multiple cameras or multiple viewpoints, one or more (e.g., each) being oriented toward different portions of the object 810A. The upper garment portion 812A can correspond to a portion of the surface of the object 810A having the red color and the sweater texture, and can be generated by the system 100. The lower garment portion 814A can correspond to a portion of the surface of the object 810A having the blue color and the denim texture, and can be generated by the system 100. For example, the system 100 can generate the upper garment portion 812A and the lower garment portion 814A in response to a text prompt for “a woman wearing a red sweater and dark jeans.”

The first camera 820 can correspond to a viewpoint oriented toward a first portion of the object 810A. For example, the first camera 820 can be oriented toward a head or hair region of the object 810A, and can detect a portion of a surface of the object 810A including at least a portion of the head or hair region of the object 810A. The first camera 820 can include a first object distance 822, a first near threshold 824, and a first far threshold 826. The first object distance 822 can correspond to a first distance in a 3D space between the first camera 820 and a surface of the object 810A.

For example, the first object distance 822 can correspond to a linear distance. The first near threshold 824 can indicate a first minimum distance in a 3D space between the first camera 820 and a surface of the object 810A. For example, the first minimum distance can be according to one or more of a diffusion model and the first camera 820, and can indicate a distance below which the diffusion model can introduce distortion into a detected surface or surface projection. The first far threshold 826 can indicate a first maximum distance in a 3D space between the first camera 820 and a surface of the object 810A. For example, the maximum distance can be according to one or more of a diffusion model and the first camera 820, and can indicate a distance beyond which the diffusion model can introduce distortion into a detected surface or surface projection.

The second camera 830 can correspond to a viewpoint oriented toward a second portion of the object 810A. For example, the second camera 830 can be oriented toward an arm or shoulder region of the object 810A, and can detect a portion of a surface of the object 810A including at least a portion of the arm or shoulder region of the object 810A. The second camera 830 can include a second object distance 832, a second near threshold 834, and a second far threshold 836.

The second object distance 832 can correspond to a second distance in a 3D space between the second camera 830 and a surface of the object 810A. For example, the second object distance 832 can correspond to a linear distance. The second near threshold 834 can indicate a second minimum distance in a 3D space between the second camera 830 and a surface of the object 810A. For example, the minimum distance can be according to one or more of a diffusion model and the second camera 830, and can indicate a distance below which the diffusion model can introduce distortion into a detected surface or surface projection. The second far threshold 836 can indicate a second maximum distance in a 3D space between the second camera 830 and a surface of the object 810A. For example, the maximum distance can be according to one or more of a diffusion model and the second camera 830, and can indicate a distance beyond which the diffusion model can introduce distortion into a detected surface or surface projection.

The third camera 840 can correspond to a viewpoint oriented toward a third portion of the object 810A. For example, the third camera 840 can be oriented toward an underarm or torso region of the object 810A, and can detect a portion of a surface of the object 810A including at least a portion of the underarm or torso region of the object 810A. For example, the third camera 840 can be oriented to detect a portion of the object 810A otherwise occluded by another portion of the object 810A. Thus, the multiple cameras or viewpoints can be oriented to provide a technical improvement of contiguous and artifact-free texture rendering. The third camera 840 can include a third object distance 842, a third near threshold 844, and a third far threshold 846.

The third object distance 842 can correspond to a third distance in a 3D space between the third camera 840 and a surface of the object 810A. For example, the third object distance 842 can correspond to a linear distance. The third near threshold 844 can indicate a third minimum distance in a 3D space between the third camera 840 and a surface of the object 810A. For example, the minimum distance can be according to one or more of a diffusion model and the third camera 840, and can indicate a distance below which the diffusion model can introduce distortion into a detected surface or surface projection. The third far threshold 846 can indicate a second maximum distance in a 3D space between the third camera 840 and a surface of the object 810A. For example, the maximum distance can be according to one or more of a diffusion model and the third camera 840, and can indicate a distance beyond which the diffusion model can introduce distortion into a detected surface or surface projection.

FIG. 8B depicts an example viewpoint capture of 3D model with complementary texture, in accordance with present implementations. As illustrated by way of example in FIG. 8B, a viewpoint capture of 3D model with complementary texture 800B can include at least an object 810B, an upper garment portion 812B, and a lower garment portion 814B.

The object 810B can correspond at least partially in one or more of structure and operation to the object 810A, and can have a surface distinct from that of the object 810A in response to a text prompt partially distinct from a text prompt provided as input to generate the object 810A. For example, the object 810B can correspond to a 3D model of a woman wearing a shirt, pants, and sneakers. For example, the object 810B can have a surface corresponding to a white top having a cotton texture and pants having a technical material texture. The upper garment portion 812B can correspond to a portion of the surface of the object 810B having the white color and the cotton texture, and can be generated by the system 100. The lower garment portion 814B can correspond to a portion of the surface of the object 810B having the white color and the denim texture, and can be generated by the system 100. For example, the system 100 can generate the upper garment portion 812B and the lower garment portion 814B in response to a text prompt for “a woman wearing white athletic outfit.”

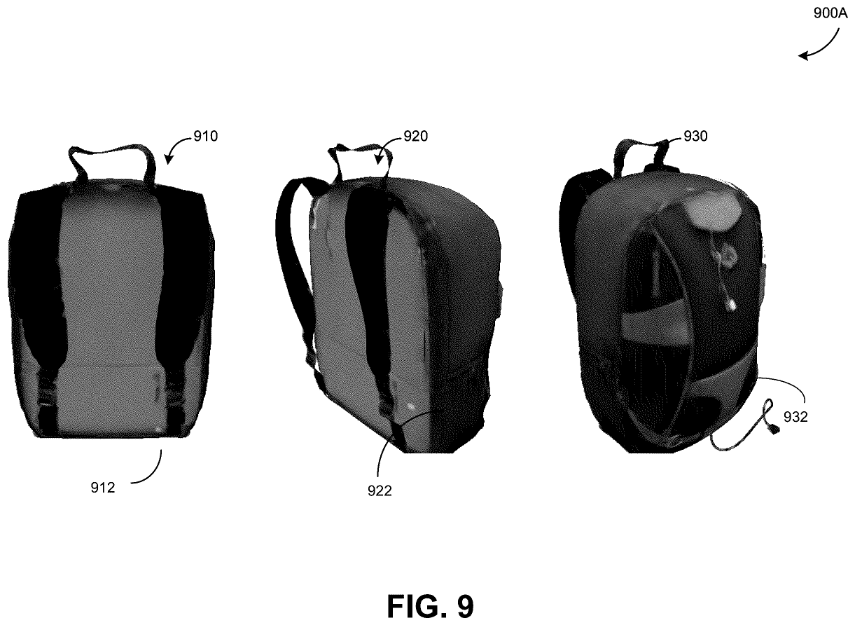

FIG. 9 depicts an example textured 3D object, in accordance with present implementations. As illustrated by way of example in FIG. 9, a textured 3D object 900 can include at least a forward view of object 910, a rotated view of object 920, and a further rotated view of object 930. For example, the texture 3D object can correspond to a backpack having a black exterior surface, a gray exterior back surface, and red accents.

The forward view of object 910 can correspond to a view of the backpack from the gray exterior back surface. The forward view of object 910 can include a textured lower edge 912. The textured lower edge 912 can correspond to a portion of the surface of the backpack including a boundary between a back surface of the backpack and a bottom surface of the backpack. The rotated view of object 920 can correspond to a view of the backpack from the gray exterior back surface, as the object is rotated along a vertical axis. The rotated view of object 920 can include a textured right edge 922. The textured right edge 922 can correspond to a portion of the surface of the backpack including a boundary between a back surface of the backpack and a side surface of the backpack. The further rotated view of object 930 can correspond to a view of the backpack from the outer exterior back surface, as the object is further rotated along the vertical axis. The further rotated view of object 930 can include a textured seam edge 932. The textured seam edge 932 can correspond to a portion of the surface of the backpack including a boundary between a first cloth piece of the backpack and a second cloth piece of the backpack.

As illustrated herein by way of example by the textured lower edge 912, the textured right edge 922, and the textured outer edge 932, this technical solution can provide a technical improvement of an artifact-free texture rendering across surface boundaries of a 3D object and viewpoint boundaries of one or more cameras.

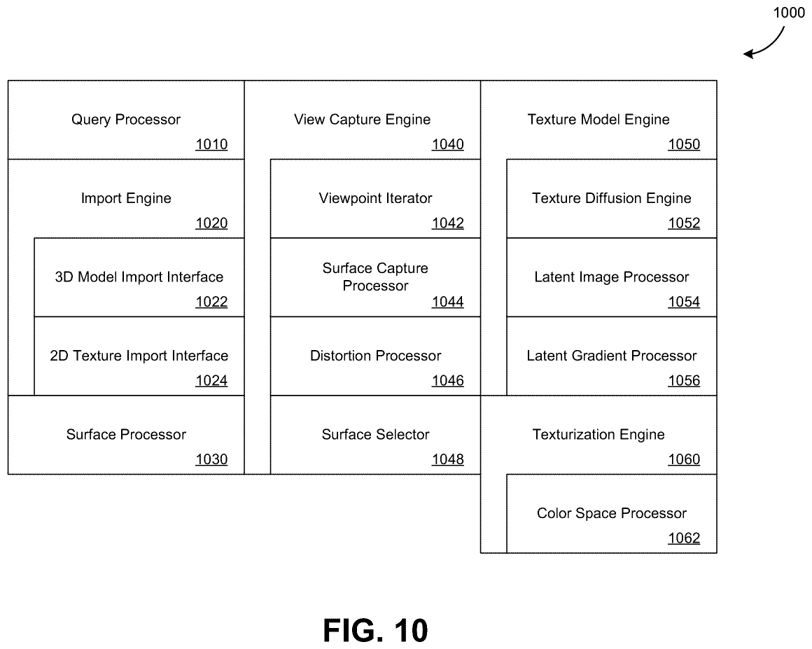

FIG. 10 depicts an example model architecture, in accordance with present implementations. As illustrated by way of example in FIG. 10, a model architecture 1000 can include at least a query processor 1010, an import engine 1020, a surface processor 1030, a view capture engine 1040, a texture model engine 1050, and a texturization engine 1060.

The query processor 1010 can obtain a query and identify one or more of a 3D object and a texture specification. For example, the query processor 1010 can identify a 3D object according to parsing a portion of the text prompt to identify a 3D object.

The import engine 1020 can obtain a 3D object according to a 3D object identified by the query processor 1010. For example, the import engine 1020 can interface with or include a repository of 3D objects, and can reference or obtain various 3D models based, for example, on an identifier of the 3D object derived from the import engine 1020. The import engine 1020 can include a 3D model import interface 1022, and a 2D texture import interface 1024. The 3D model import interface 1022 can include a communication interface configured to be compatible with a repository of 3D models, and can obtain one or more 3D models or references to 3D models corresponding to a particular 3D object. For example, the 3D model import interface 1022 can include an application programing interface (“API”) compatible with a repository of 3D models. The 2D texture import interface 1024 can include a communication interface configured to be compatible with a repository of 2D textures, and can obtain one or more 2D models or references to 2D textures corresponding to a particular text prompt. For example, the 2D texture import interface 1024 can include an application programing interface (“API”) compatible with a repository of 2D textures. The surface processor 1030 can apply an obtained 2D texture to an obtained 3D object. For example, the surface processor 1030 can “wrap” an obtained 3D object in an obtained 2D texture. For example, the surface processor 1030 can apply a latent image or a latent gradient to the 3D object in accordance with the surface projection 200 applied to the object 102. As discussed herein, “3D object” and “3D model” can be used interchangeably.

The view capture engine 1040 can obtain 2D textures corresponding to one or more portions of a surface projection on a 3D object. The view capture engine 1040 can include a viewpoint iterator 1042, a surface capture processor 1044, a distortion processor 1046, and a surface selector 1048. The viewpoint iterator 1042 can sequentially or selectively select viewpoints or cameras to capture portions of a surface of a 3D object. For example, the viewpoint iterator 1042 can sequentially select a plurality of cameras according to an “inner loop” that occurs once during each iteration of the diffusion model. The surface capture processor 1044 can capture a portion of a surface of a 3D object from a first viewpoint, and can sequentially select one or more viewpoints to collectively detect a surface of the 3D object and generate a surface projection for the 3D object. Thus, the viewpoint iterator 1042 and the surface capture processor 1044 can collectively or cooperatively generate a surface projection according to a 3D object.

The distortion processor 1046 can identify a distortion metric associated with one or more distortion thresholds of a particular viewpoint. The distortion processor 1046 can obtain or otherwise receive camera input from viewpoints that satisfy one or more thresholds corresponding to a diffusion model. For example, one or more (e.g., each) pixel of a surface projection of a surface of a 3D object can be associated with one or more cameras or viewpoints that are oriented to detect that pixel. A determination can be made to select a viewpoint among a plurality of viewpoints that satisfies one or more thresholds. For example, the thresholds can be associated with a diffusion model. For example, a diffusion model may detect a pixel on a surface of a 3D object at a lower accuracy if a viewpoint is placed closer than a near threshold or farther than a far threshold. A near threshold can correspond to a minimum distance between a viewpoint and a surface of a 3D object that can result in an accurate detection of a portion of the surface of the 3D object within a field of view of the viewpoint. For example, the near threshold can be based on one or more properties of a diffusion model. For example, a first viewpoint may be placed to view a point at a distance from a surface of a 3D object outside the distance thresholds of the diffusion model, while another viewpoint may be placed to view a point at a distance from a surface of a 3D object within the distance thresholds of the diffusion model, thus, the depth conditioning can select the camera viewing the point within the distance thresholds, to achieve the technical improvement of increased accuracy of output generated by a diffusion model.

For example, the distortion processor 1046 can identify one or more portions of a surface detected by a particular viewpoint as within or outside one or more of a minimum distance threshold and a maximum distance threshold. For example, the distortion processor 1046 can identify which portions of a detected surface are within thresholds for distortion by a diffusion model. For example, the distortion processor 1046 can identify portions of a surface on a pixel-by-pixel basis. The surface selector 1048 can select portions of detected surfaces to generate a surface projection corresponding to a surface of a 3D object. For example, the surface selector 1048 can identify portions of a detected surface from one or more viewpoints, and can generate a surface projection by combining portions of the detected surface that are determined by the distortion processor 1046 as satisfying one or more distance thresholds.

The texture model engine 1050 can generate or model a 2D texture or a latent image or latent gradient corresponding to the 2D texture. For example, the texture model engine 1050 can develop and modify a 2D texture or latent image by the system 100, over one or more iterations indicated by FIG. 3 over time. For example, the operation of the texture model 1050 can correspond to an “outer loop” of the diffusion model process, in which an “inner loop” is applied to provide a surface projection to the diffusion model for each iteration of the diffusion model. The texture model engine 1050 can include a texture diffusion engine 1052, a latent image processor 1054, and a latent gradient processor 1056.

The texture diffusion engine 1052 can assemble one or more portions of a surface projection selected by the surface selector 1048 into a latent image to be provided as input to a diffusion model corresponding to the latent image processor 1054. The latent image processor 1054 can process a latent image according to a diffusion model. For example, the latent image processor 1054 can correspond to the diffusion model 603, and can obtain at least the image 620 and generate the texture 640. The latent gradient processor 1056 can generate a latent gradient according to a latent image. For example, the latent gradient processor 1056 can generate the latent gradient 650 according to the latent texture 640.

The texturization engine 1060 can generate a 2D texture according to a latent image or a latent gradient. For example, the texturization engine 1060 can convert a latent image space to a color space in response to receiving or according to an indication of a color space. The color space can be defined, for example, in a text prompt or with respect to a particular video processing component of a computing system. The texturization engine 1060 can include a color space processor 1062. The color space processor 1062 can transform a latent image or a latent gradient into a 2D image according to a particular color space. For example, the color space processor 1062 can transform a latent image or latent gradient into an RGB color space or a CMYK color space.

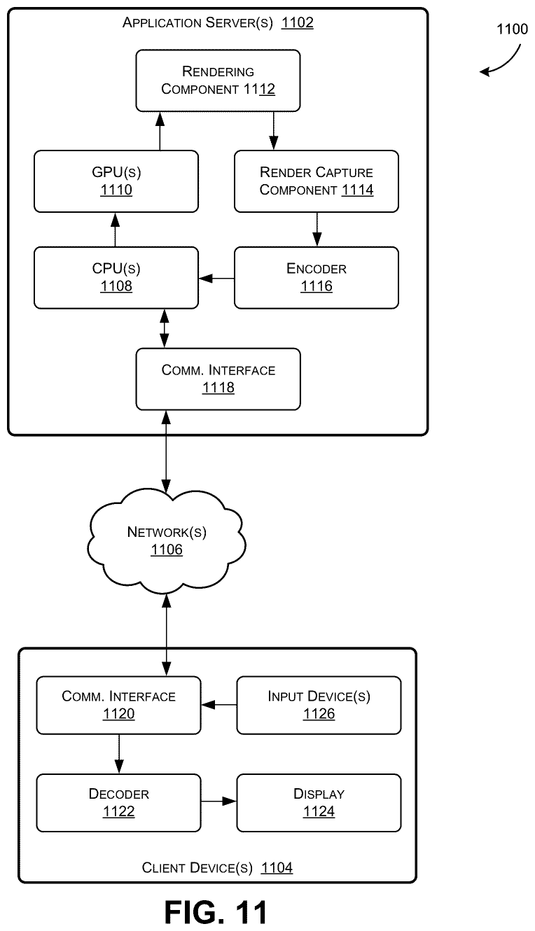

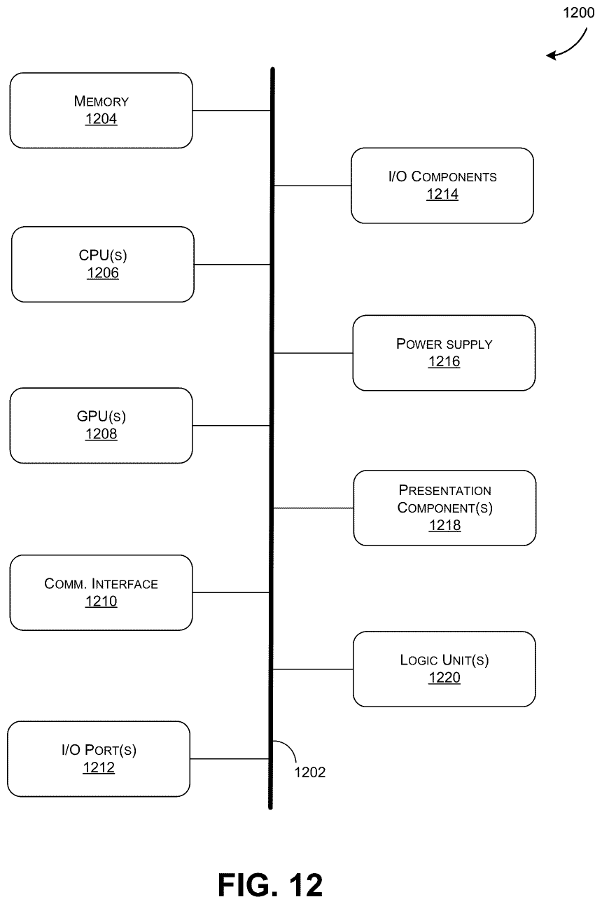

FIG. 11 depicts an example network system, in accordance with present implementations. As illustrated by way of example in FIG. 11, an example network system 1100 can include at least application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented to perform diffusion model training and runtime operations. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 1100 can be implemented to receive input indicating one or more features of output to be generated using a diffusion model, provide the input to the model to cause the model to generate the output, and the output.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the game server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 according to receiving the display data from the application server(s) 1102. The client device 1104 may receive an input to one of the input device(s) and generate input data in response, such as to provide modification inputs of a driving signal for use by modifier 112. The client device 1104 may transmit the input data to the application server(s) 1102 according to the communication interface 1120 and over the network(s) 1106 (e.g., the Internet), and the application server(s) 1102 may receive the input data according to the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc.—may be used by the application server(s) 1102 to support the application sessions. The encoder 1116 may then encode the display data to generate encoded display data and the encoded display data may be transmitted to the client device 1104 over the network(s) 1106 according to the communication interface 1118. The client device 1104 may receive the encoded display data according to the communication interface 1120 and the decoder 1122 may decode the encoded display data to generate the display data. The client device 1104 may then display the display data according to the display 1124.

FIG. 12 depicts an example computer system, in accordance with present implementations. As illustrated by way of example in FIG. 12, an example computer system 1200 can include at least an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected according to the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may be arranged in various topologies, including but not limited to bus, star, ring, mesh, tree, or hybrid topologies. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received according to a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., according to a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices according to an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208. In some embodiments, a plurality of computing devices 1200 or components thereof, which may be similar or different to one another in various respects, can be communicatively coupled to transmit and receive data for performing various operations described herein, such as to facilitate latency reduction.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user, such as to generate a driving signal for use by modifier 112, or a reference image (e.g., images 104). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

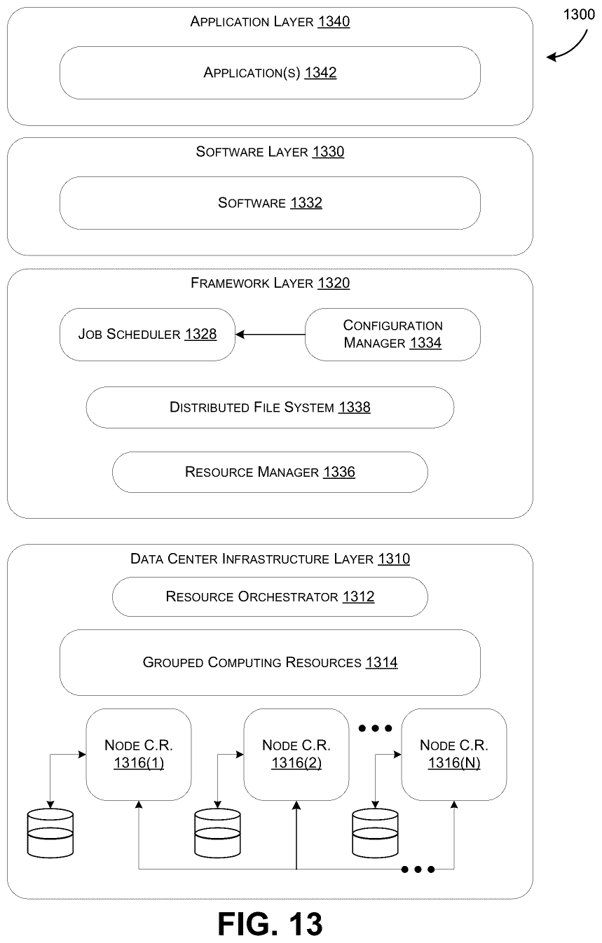

FIG. 13 depicts an example computer architecture, in accordance with present implementations. As illustrated by way of example in FIG. 13, an example computer architecture 1300 can include at least a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-1316 (N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104, 204.

In at least one embodiment, any of configuration manager 1334, resource manager 1336, and resource orchestrator 1312 may implement any number and type of self-modifying actions according to any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models (e.g., train machine learning models of modifier 112) or predict or infer information using one or more machine learning models (e.g., machine learning models of modifier 112) according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

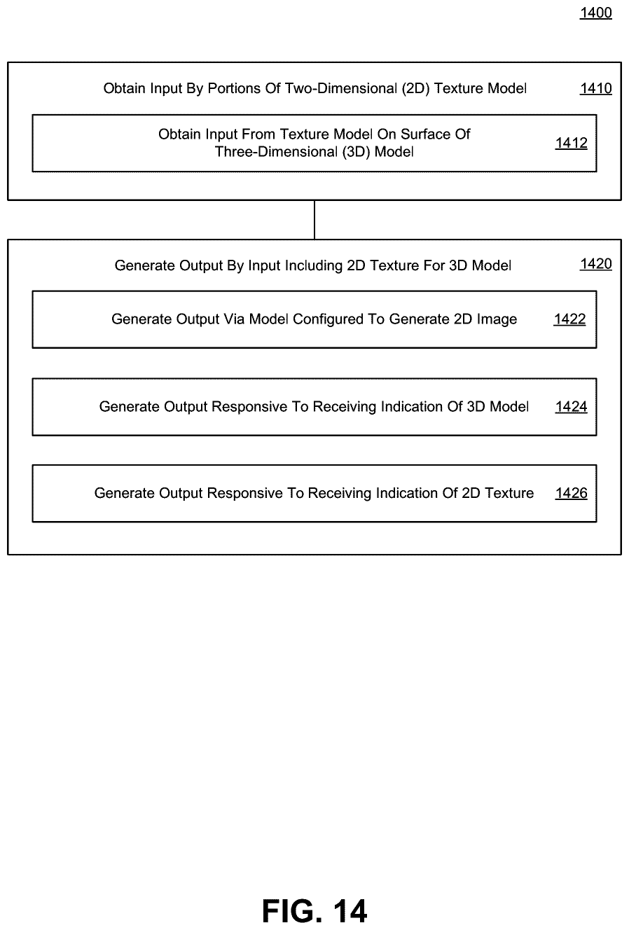

FIG. 14 depicts a method 1400 of texture generation for three-dimensional models according to text-based prompt input, in accordance with present implementations. At least the system 100, the system 1100, the system 1200, or the architecture 1300, or any component thereof, can perform the method 1400. For example, the method 1400 can iterate in an “outer loop” over multiple times t within or over a time range T. For example, in each “outer loop” iteration, the method 1400 can generate or obtain a diffusion map Z.

At 1410, the method 1400 can obtain input according to portions of a two-dimensional (2D) texture model. At 1412, the method 1400 can obtain input from a texture model on a surface of a three-dimensional (3D) model. For example, the method 1400 can iterate in an “inner loop” over multiple viewpoints or cameras oriented toward the surface of the 3D model. For example, the method 1440 can generate, render, or capture a portion of the surface of the 3D object. For example, the method 1400 can determine, within an inner loop, that one or more pixels detected at a surface satisfy one or more distance thresholds corresponding to one or more of the viewpoint and the machine vision model. For example, the method 1400 can apply a mask to one or more pixels that satisfy or do not satisfy one or more distance thresholds. For example, the method 1400 can apply a mask to ignore one or more pixels at a distance from a surface of a 3D object farther than a far threshold or nearer that a near threshold to a viewpoint.

At 1420, the method 1400 can generate an output according to the input including a 2D texture for the 3D model. At 1422, the method 1400 can generate the output according to a machine vision model configured to generate a 2D image. For example, a machine vision model can generate, modify, or detect, but is not limited thereto, 2D or 3D image data. For example, the output can correspond to an output of a diffusion model (DDIM). For example, the diffusion model can render the surface on a per-viewpoint basis within the inner loop. For example, the diffusion model can render the surface in an outer loop after all viewpoints are captured in the inner loop. For example, the diffusion model can render the surface based on unmasked pixels or by excluding masked pixels. For example, the method 1440 can append, to the diffusion map Z, each output of the diffusion model in the inner loop, or the output of the diffusion model in the outer loop. For example, the output can correspond to a mean of one or more portions or aspects of the diffusion map Z. At 1424, the method 1400 can generate the output responsive to receiving an indication of the 3D model. At 1426, the method 1400 can generate the output responsive to receiving an indication of the 2D texture.

The foregoing can be implemented as below, including according to a processor. For example, the processor can transform, according to a diffusion model corresponding to the machine vision model, the 2D texture model to reduce noise in the 2D texture model according to the indication corresponding to the 2D texture. For example, the processor can transform, in a first iterative order according to a diffusion model corresponding to the machine vision model, each of a plurality of portions of the 2D texture model to reduce noise in the 2D texture model, where the 2D texture corresponds to the output subsequent to the first iterative order.

For example, each of the plurality of the portions of the 2D texture model respectively correspond to one of the views of the 2D texture model. For example, the processor can transform, according to the diffusion model in a second iterative order, the portions of the 2D texture model to reduce noise in the 2D texture model, the second iterative order restricting the diffusion model to one or more iterations according to the first iterative model, where the 2D texture corresponds to the output subsequent to a plurality of iterations according to the first iterative order according the second iterative order.

For example, the processor can allocate, according to a distance between a camera among the plurality of cameras and a portion of the surface of the 3D object, a metric to the portion of the surface of the 3D object and generate, according to the metric, the output. For example, the processor can allocate, according to a determination that the distance satisfies a threshold corresponding to a distortion caused by a diffusion model, the metric, where the metric comprises a weight to the portion of the surface of the 3D object for the model that satisfies the threshold.

For example, the processor can identify, according to a first camera among the plurality of cameras having a first view can include a portion of the 2D texture model on the surface of the 3D model, a first metric indicating a first degree of distortion caused by a diffusion model. The processor can identify, according to a second camera among the plurality of cameras having a second view that can include the portion of the 2D texture model on the surface of the 3D model, a second metric indicating a second degree of distortion caused by the diffusion model. The processor can select, according to a determination that the first degree of distortion is less than or equal to the second degree of distortion, the input to include the first view.

For example, the processor is comprised in at least one of a control system for an autonomous or semi-autonomous machine. The system can comprise a perception system for an autonomous or semi-autonomous machine. The system can comprise a system for performing simulation operations. The system can comprise a system for performing digital twin operations. The system can comprise a system for performing light transport simulation. The system can comprise a system for performing collaborative content creation for 3D assets. The system can comprise a system for performing deep learning operations. The system can comprise a system implemented using an edge device. The system can comprise a system implemented using a robot. The system can comprise a system for performing conversational AI operations. The system can comprise a system for generating synthetic data. The system can comprise a system incorporating one or more virtual machines (VMs). The system can comprise a system implemented at least partially in a data center. The system can be implemented at least partially using cloud computing resources.

For example, the system can transform, according to a diffusion model corresponding to the model and receiving the indication, the 2D texture model to reduce noise in the 2D texture model according to the indication corresponding to the 2D texture. For example, the system can transform, in a first iterative order according to a diffusion model corresponding to the model, each of the plurality of portions of the 2D texture model to reduce noise in the 2D texture model, where the 2D texture corresponds to the output subsequent to the first iterative order. For example, the plurality of the portions of the 2D texture model correspond to the plurality of views of the 2D texture model according to a plurality of cameras oriented toward the surface of the 3D model. For example, the system can transform, according to the diffusion model in a second iterative order, the 2D texture model to reduce noise in the 2D texture model, the second iterative order restricting the diffusion model to one or more iterations according to the first iterative model, where the 2D texture corresponds to the output subsequent to a plurality of iterations according to the first iterative order according the second iterative order.

For example, the system can allocate, according to a distance between a camera among a plurality of cameras oriented toward the surface of the 3D model and a portion of the surface of the 3D object, a metric to the portion of the surface of the 3D object. The system can generate, according to the metric, the output. For example, can allocate, according to a determination that the distance satisfies a threshold corresponding to a distortion of output of a diffusion model, the metric, where the metric comprises a weight to the portion of the surface of the 3D object for the model that satisfies the threshold.

For example, the system can identify, according to a first camera among the plurality of cameras having a first view can include a portion of the 2D texture model on the surface of the 3D model, a first metric indicating a first degree of distortion of output of a diffusion model. The system can identify, according to a second camera among the plurality of cameras having a second view can include the portion of the 2D texture model on the surface of the 3D model, a second metric indicating a second degree of distortion of output of the diffusion model. The system can select, according to a determination that the first degree of distortion is less than or equal to the second degree of distortion, the views to include the first view.

For example, the system can include a processor comprised in at least one of a control system for an autonomous or semi-autonomous machine. The system can correspond to a perception system for an autonomous or semi-autonomous machine. The system can correspond to a system for performing simulation operations. The system can correspond to a system for performing digital twin operations. The system can correspond to a system for performing light transport simulation. The system can correspond to a system for performing collaborative content creation for 3D assets. The system can correspond to a system for performing deep learning operations. The system can correspond to a system implemented using an edge device. The system can correspond to a system implemented using a robot. The system can correspond to a system for performing conversational AI operations. The system can correspond to a system for generating synthetic data. The system can correspond to a system incorporating one or more virtual machines (VMs). The system can correspond to a system implemented at least partially in a data center. The system can correspond to a system implemented at least partially using cloud computing resources.

For example, the computer readable medium can include one or more instructions executable by a processor. The processor can transform, according to a diffusion model corresponding to the model, the 2D texture model to reduce noise in the 2D texture model according to the indication corresponding to the 2D texture.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A processor comprising:
one or more circuits to:
obtain an input according to one or more views from a plurality of viewpoints of a two-dimensional (2D) texture model, the 2D texture model corresponding to a surface of a three-dimensional (3D) model; and
generate, using a generative machine learning model and according to the input, an output that includes a 2D texture for the 3D model, the output corresponding to an indication of the 3D model and the 2D texture.

2. The processor of claim 1, wherein the generative machine learning model comprises a diffusion model, and the one or more circuits are to:
transform, using the diffusion model, the 2D texture model to reduce noise in the 2D texture model according to the indication corresponding to the 2D texture.

3. The processor of claim 1, wherein the one or more circuits are further to transform, in a first iterative order according to a diffusion model corresponding to the generative machine learning model, one or more of a plurality of portions of the 2D texture model to reduce noise in the 2D texture model,
wherein the 2D texture corresponds to the output subsequent to the first iterative order.

4. The processor of claim 3, wherein one or more of the plurality of the portions of the 2D texture model respectively correspond to one or more of the views of the 2D texture model.

5. The processor of claim 3, wherein the one or more circuits are further to:
transform, according to the diffusion model in a second iterative order, the portions of the 2D texture model to reduce noise in the 2D texture model, the second iterative order restricting the diffusion model to one or more iterations according to the first iterative model,
wherein the 2D texture corresponds to the output subsequent to a plurality of iterations according to the first iterative order according the second iterative order.

6. The processor of claim 1, wherein the one or more circuits are further to:
allocate, according to a distance between a viewpoint among the plurality of viewpoints and a portion of the surface of the 3D object, a metric to the portion of the surface of the 3D object; and
generate the output according to the metric.

7. The processor of claim 6, wherein the one or more circuits are further to:
allocate the metric according to a determination that the distance satisfies a threshold corresponding to a distortion caused by a diffusion model, wherein the metric comprises a weight to the portion of the surface of the 3D object for the model that satisfies the threshold.

8. The processor of claim 1, wherein the one or more circuits are further to:
identify, according to a first viewpoint among the plurality of viewpoints having a first view including a portion of the 2D texture model on the surface of the 3D model, a first metric indicating a first degree of distortion caused by a diffusion model; and
identify, according to a second viewpoint among the plurality of viewpoints having a second view including the portion of the 2D texture model on the surface of the 3D model, a second metric indicating a second degree of distortion caused by the diffusion model; and
select, according to a determination that the first degree of distortion is less than or equal to the second degree of distortion, the input to include the first view.

9. The processor of claim 1, wherein the processor is comprised in at least one of a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for generating content for a virtual reality (VR), an augmented reality (AR), or a mixed reality (MR) system;
a system for rendering content for a virtual reality (VR), an augmented reality (AR), or a mixed reality (MR) system;
a system incorporating one or more virtual machines (VMs);
a system implemented at least partially in a data center; or
a system implemented at least partially using cloud computing resources.

10. A system comprising:
one or more processors configured to:
obtain one or more views of a three-dimensional (3D) model from a set of vantage points that at least partially envelopes a surface of the 3D model, at least one view of the one or more views corresponding to a portion of a two-dimensional (2D) texture model on the surface of the 3D model; and
generate, according to the one or more views and according to a generative machine learning model configured to generate a 2D image, an output that includes a 2D texture for the 3D model, the output corresponding to an indication of the 3D model and the 2D texture.

11. The system of claim 10, wherein the system is to:
transform, according to a diffusion model corresponding to the generative machine learning model and receiving the indication, the 2D texture model to reduce noise in the 2D texture model according to the indication corresponding to the 2D texture.

12. The system of claim 10, wherein the system is to:
transform, in a first iterative order according to a diffusion model corresponding to the generative machine learning model, one or more of the plurality of portions of the 2D texture model to reduce noise in the 2D texture model,
wherein the 2D texture corresponds to the output subsequent to the first iterative order.

13. The system of claim 12, wherein the plurality of the portions of the 2D texture model correspond to the plurality of views of the 2D texture model according to a plurality of viewpoints oriented toward the surface of the 3D model.

14. The system of claim 12, wherein the system is to:
transform, according to the diffusion model in a second iterative order, the 2D texture model to reduce noise in the 2D texture model, the second iterative order restricting the diffusion model to one or more iterations according to the first iterative model,
wherein the 2D texture corresponds to the output subsequent to a plurality of iterations according to the first iterative order according the second iterative order.

15. The system of claim 10, wherein the system is to:
allocate, according to a distance between a viewpoint among a plurality of viewpoints oriented toward the surface of the 3D model and a portion of the surface of the 3D object, a metric to the portion of the surface of the 3D object; and
generate the output according to the metric.

16. The system of claim 15, wherein the system is to allocate, according to a determination that the distance satisfies a threshold corresponding to a distortion of output of a diffusion model, the metric,
wherein the metric comprises a weight to the portion of the surface of the 3D object for the model that satisfies the threshold.

17. The system of claim 10, wherein the system is to:
identify, according to a first viewpoint among the plurality of viewpoints having a first view including a portion of the 2D texture model on the surface of the 3D model, a first metric indicating a first degree of distortion of output of a diffusion model; and
identify, according to a second viewpoint among the plurality of viewpoints having a second view including the portion of the 2D texture model on the surface of the 3D model, a second metric indicating a second degree of distortion of output of the diffusion model; and
select, according to a determination that the first degree of distortion is less than or equal to the second degree of distortion, the views to include the first view.

18. The system of claim 10, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system for generating content for a virtual reality (VR), an augmented reality (AR), or a mixed reality (MR) system;
a system for rendering content for a virtual reality (VR), an augmented reality (AR), or a mixed reality (MR) system;
a system incorporating one or more virtual machines (VMs);
a system implemented at least partially in a data center; or
a system implemented at least partially using cloud computing resources.

19. A method comprising:
obtaining input according to a plurality of portions of a two-dimensional (2D) texture model on a surface of a three-dimensional (3D) model; and
generating, according to the input and using a generative machine learning model, an output including a 2D texture for the 3D model, the output corresponding to an indication of the 3D model and the 2D texture.

20. The method of claim 19, wherein the generative machine learning model comprises a diffusion model, and wherein the method further includes:
transforming, using the diffusion model, the 2D texture model to reduce noise in the 2D texture model according to the indication corresponding to the 2D texture.
